(19) United States
(12) Patent Application Publication
(10) Pub. No.: US 2015/0192944 A1
(43) Pub. Date: Jul. 9, 2015

(54) Power Socket and Method for Monitoring Appliance Event of Load

(71) Applicant: Metalligence Technology Corporation, Hsinchu (TW)

(72) Inventors: Shiao-Li TSAO, Taipei City (TW); Ming-Ling LO, New Taipei City (TW)

(73) Assignee: Metalligence Technology Corporation, Hsinchu (TW)

(21) Appl. No.: 14/280,658

(22) Filed: May 18, 2014

(30) Foreign Application Priority Data
Jan. 8, 2014 (TW) 103100693

(51) Int. Cl. G05F 1/66; G05B 15/02

(52) U.S. Cl. CPC G05F 1/66; G05B 15/02

(57) ABSTRACT

A power socket which monitors an appliance event of a load includes a power sensor, a front-end signal filter, a microprocessor, and a memory electrically connected to the microprocessor. The power sensor senses a power signal induced by the appliance event of the load and accordingly generates at least one sense signal. The front-end signal filter filters the sense signal according to a filtering criteria, in which the sense signal is filtered out or passed by the front-end signal filter. The microprocessor analyzes the sense signal which is passed to identify whether the passed sense signal is in accordance with a configurable event set. A configuration action is performed through an instruction of the microprocessor when the passed sense signal is analyzed and identified in accordance with the configurable event set.

### RELATED APPLICATIONS

This application claims priority to Taiwan Application Serial Number 103100693, filed Jan. 8, 2014, which is herein incorporated by reference.

### BACKGROUND

1. Field of Invention

The present disclosure relates to an appliance event. More particularly, the present disclosure relates to monitoring and identifying of the appliance event.

2. Description of Related Art

With the rapid development of the electronic technology in recent years, many kinds of electronic equipments have been developed with various electricity characteristics. Some of the electronic equipments are able to operate with minimum power supplying while others consumes a great amount of power in operation. Optimizing the operations of the electronic equipments becomes more and more important concerning environmental and energy saving issues. Furthermore, proper operations of the electronic equipments closely relate to safety issues in use of the electronic equipments. In this regard, electrical safety regulations and standards for the power sockets are provided by authority or certain institutions to regulate the usage of the electronic equipments.

Conventional power sockets may provide simple threshold-power control and usage-time control for managing the on-off states of the power sockets. For example, users or administrators may specify the upper bound of the power or time period that a power socket can supply the plugged appliances. If the power or the time period consumed by the plugged appliances exceeds the threshold/period, the power socket may alarm and/or automatically cut off the power. However, the power management of the power socket through the configurations such as the upper bound of power or time period are insufficient in that unsafe electronic equipments are still possibly unauthorizedly connected to the power sockets and cause blind spots in the electrical safety.

The Massachusetts Institute of Technology (MIT) developed in 1980s the technique of nonintrusive load monitoring (NILM), also called nonintrusive appliance load monitoring (NIALM), which only needs a single meter to disaggregate the usage and the power consumption of appliances on an electrical circuit loop according to different signatures of the appliances and their states. The signature of an appliance or the appliance state means the change in waveform of voltage and current of the electrical circuit when the appliance is turned on, off or in change of the states.

However, the NIALM is still considered insufficient because the analyzing and identifying capability of the NIALM is limited and inefficient when many electronic equipments of similar or various features are connected to the same electrical circuit loop. As a result, further improvements in the power management of the power socket are required.

### SUMMARY

According to one embodiment of the present invention, a power socket for monitoring an appliance event of a load is disclosed, in which the power socket includes a power sensor, a front-end signal filter, a microprocessor, and a memory electrically connected to the microprocessor.

The power sensor senses at least one power signal induced by the appliance event of the load and generates at least one sense signal accordingly. The front-end signal filter filters the sense signal, in which the sense signal is filtered out or passed by the front-end signal filter according to a filtering criterion. The microprocessor analyzes the sense signal which is passed to identify whether the passed sense signal is in accordance with a configurable event set, in which a configuration action is performed by the power socket through an instruction of the microprocessor when the passed sense signal is analyzed and identified in accordance with the configurable event set.

According to another embodiment of the present invention, a method for monitoring an appliance event of a load is disclosed. In the method, at least one power signal induced by the appliance event of the load is sensed, and a sense signal which is corresponding to the power signal is filtered according to a filtering criterion to filter out or to pass the sense signal. The sense signal which is passed is analyzed to identify whether it is in accordance with a configurable event set. A power socket is instructed to perform a configuration action when the passed sense signal is analyzed and identified in accordance with the configurable event set. No configuration action is performed when the passed sense signal is not in accordance with the configurable event set.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a structure diagram of a power socket system according to a first embodiment of the present invention;

FIG. 2 is a software structure diagram of the power socket according to the first embodiment of the present invention;

FIG. 3 is a diagram of a display device according to a second embodiment of the present invention;

FIG. 4A is a part flowchart of a method for monitoring an appliance event according to a third embodiment of the present invention;

FIG. 4B is another part flowchart of the method for monitoring the appliance event according to the third embodiment of the present invention;

FIG. 4C is a remaining part flowchart of the method for monitoring the appliance event according to the third embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terms used in this specification generally have their ordinary meanings in the art, within the context of the invention, and in the specific context where each term is used. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms.

The power socket and the method for monitoring an appliance event of the following embodiments can block some appliance events through the front-end signal filter according to the filtering criteria, these blocked appliance event requires no further processing of the microprocessor, which reduces the burden of the microprocessor and improves the efficiency of identifying.

In addition, users or administrators can specify the configurable event set that the power socket should detect and the actions that the power socket should take for responding the events. The configurable event set and response actions can be flexibly configured by the users and the administrators and can be uploaded/downloaded/shared among users through a common service platform, which improves the flexibility and the expandability.

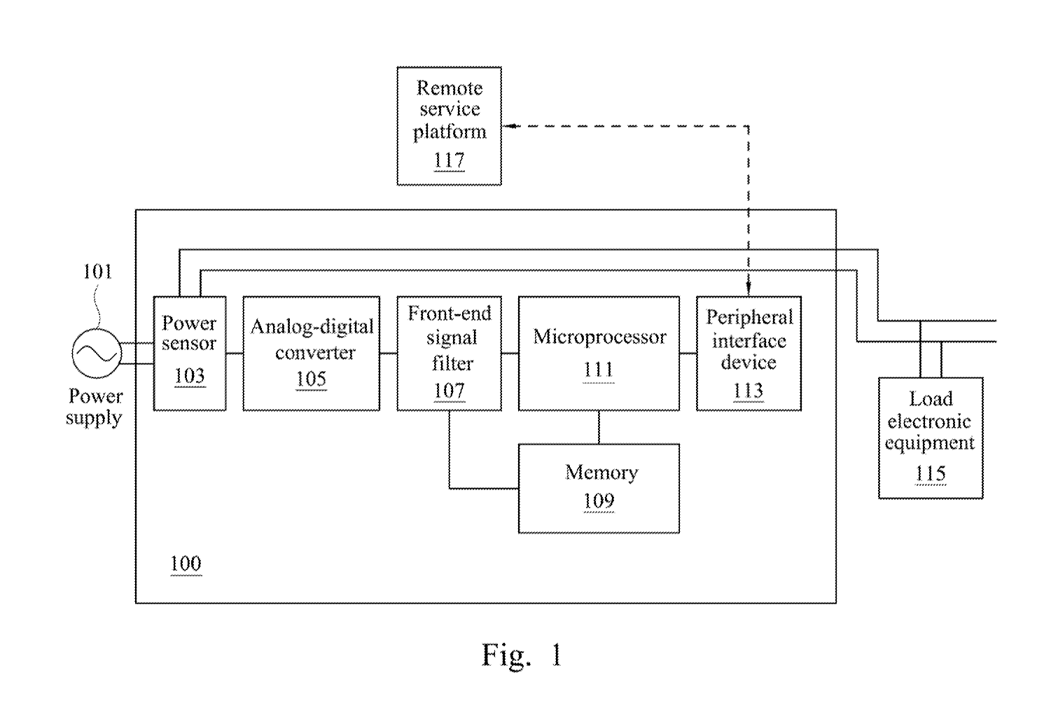

FIG. 1 is a structure diagram of a power socket system according to a first embodiment of the present invention. The power socket 100, disposed between the power supply 101 and the load electronic equipment 115, is responsible for passing the power supply 101 and for managing status of the load electronic equipment 115, in which the power supply 101 can be a direct current source or an alternating current source. The power socket 100 also detects and manages appliance events of the load electronic equipment 115, in which the appliance events can be any kind of events which might consume power, such as a turning on action or a charging action of a general fan, a specific fan, a light, an electronic consumer device, a dehumidifier, an electronic cooking device, an air conditioner, and a heater. For safety, economics, and management considerations, the administrators need to monitor and govern the operations of the electronic equipment through the power socket 100, and corresponding estimations as well as the response actions are further conducted.

The power socket 100 includes a power sensor 103, a front-end signal filter 107, a microprocessor 111, and a memory 109 electrically connected to the microprocessor 111. The power sensor 103 senses at least one power signal induced by the appliance event of the load electronic equipment 115 and accordingly generates at least one sense signal or other signals, in which the induced power signal might be a current signal, a voltage signal, a sound signal, a temperature signal, or even an electromagnetic wave signal, and so on. The analog-digital converter 105 is electrically connected to the power sensor 103. When the induced power signal is of analog type, the analog-digital converter 105 converts the sense signal from the analog type into a digital type.

The front-end signal filter 107 filters the sense signal according to a filtering criterion to filter out or pass the sense signal, in which the front-end signal filter 107 can be implemented through a hardware circuit such as a digital signal processor (DSP) with a corresponding firmware, a field-programmable gate array (FPGA), or an application specific Integrated circuit (ASIC).

The front-end signal filter 107 and the filtering criteria can be built in the power socket 100 in advance or downloaded and updated through a network or Internet. The front-end signal filter 107 and the filtering criteria specify the conditions that further examinations are no longer required. For example, if the filtering criteria specify the minimum power consumption, the front-end signal filter 107 filters out the sense signal that will be ignored and will not be further processed by the microprocessor 111 when the power consumption that the appliance event consumes is less than the minimum power consumption, which reduces the unnecessary power consumption.

The microprocessor 111 analyzes the sense signal which has been passed to identify whether the sense signal which has been passed is according with a configurable event set. Particularly, the microprocessor 111 stops the analyzing and the identifying if all of the sense signals are filtered out and no signal is remained, which saves the power consumption. The configurable event set substantially includes the turning on action or the charging action of a general fan, a specific fan, a light, an electronic consumer device, a dehumidifier, an electronic cooking device (such as an immersion heater), an air conditioner, and a heater that consumes power or energy. The under test signature is extracted from the passed sense signal when the microprocessor 111 performs the analyzing and the identifying.

The power socket 100 further includes a peripheral interface device 113 that connected to a remote service platform 117 to perform a data transmission. For example, the power socket 100 can communicate with the remote service platform 117 through the peripheral interface device 113 which can be a wireless local area network device, an Ethernet device, a 3G device, or a 4G device, to download the filtering criteria.

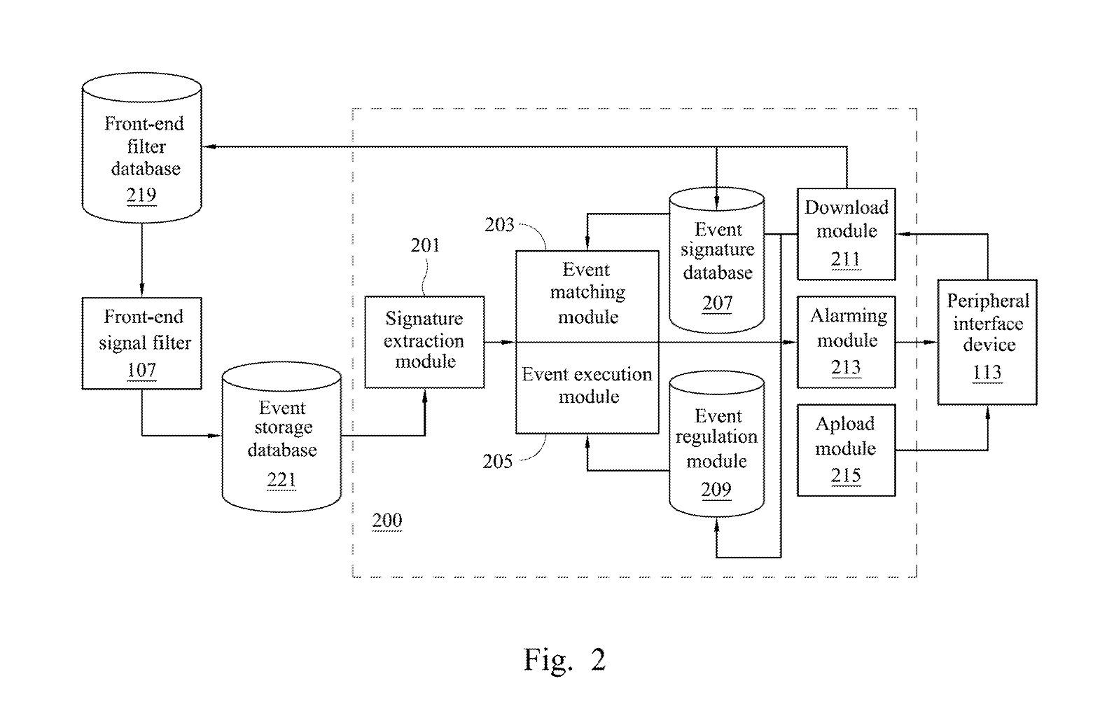

FIG. 2 is a software structure diagram of the power socket system according to a second embodiment of the present invention. The event storage database 221 stores the passed sense signal that can be uploaded to the remote service platform through the peripheral interface device, such that the passed sense signal can be shared among the users and referenced by other users. The front-end filter database 219 storages the settings of the front-end signal filter, the filtering criteria, and the setting of the filtering criteria, which includes at least one of hardware setting, software settings, firmware setting (such as bit-streams of a program record file) of the front-end signal filter, and a record file of the filtering criteria. These settings can be built-in or downloaded through the network and can be used to set the front-end signal filter 107.

The software module 200 substantially includes a signature extraction module 201, an event signature database 207, and an event matching module 203.

The signature extraction module 201 is stored in the memory and executed by the microprocessor to extract at least one under test signature from the sense signal which is passed, in which the under test signature can be at least one of a real power, a reactive power, a root-mean-square, a harmonica, a voltage characteristic, and a current characteristic of the appliance event of the load. For example, the under test signature can be the increasing speed of the current or the voltage; the under test signature can even be the ripple characteristic of the appliance event. The event signature database 207 stores the signature information that is corresponding to the configurable event set, in which the configurable event set can be initially built-in the event signature database 207 or downloaded through the network to the event signature database 207. The event matching module 203 is stored in the memory and is executed by the microprocessor to check whether the under test signature corresponds to the configurable event set.

If the signature set is presented as Eᵢ={S₁ⁱ, S₂ⁱ, . . . , Sₙⁱ}, in which S₁ⁱ represents the first signature of the iₜₕ event, the event signature database 207 stores the signatures of the configurable event set of the power socket and the signature similarity matching function F₁^{j}(x), F₂^{j}(x), . . . , Fₙ^{j}(x), in which F₁^{j}(S₁ⁱ) represents the similarity between the first signature of the iₜₕ event and the first signature of the jₜₕ electronic equipment set in the database, which satisfies 0≦F₁^{j}(S₁ⁱ)≦1. The signature information Eᵢ={S₁ⁱ, S₂ⁱ, . . . , Sₙⁱ} of iₜₕ event is inputted into the jₜₕ similarity matching function, and

$${\prod }_{k = 1}^{n} {ω}_{k} {F}_{k}^{j} ( {S}_{k}^{i} )$$

is derived through combining all the signatures, in which ωₖ is the important factor of the signature K.

The software module 200 further includes an event regulation module 209 and an event execution module 205. The event regulation module 209 is stored in the memory, and a plenty of event handling regulations are recorded by the event regulation module 209, in which these event handling regulations can be initially built-in the event regulation module 209 or can be downloaded into the event regulation module 209 through the network. The event execution module 205 is stored in the memory and executed by the microprocessor. When the under test signature is corresponding to the configurable event set, the configuration action is performed through the instruction from the microprocessor. For example, the microprocessor instructs the event execution module 205 to handle the appliance event of the load according to the event handling regulations.

The alarming module 213 is also stored in the memory and executed by the microprocessor, in which the alarming module 213 is controlled by the event execution module 205 to perform at least one alarming action. The alarming module 213 sends a notice message to the remote service platform through the peripheral interface device 113. The alarming module 213 will make warning sounds or cut-off the power supply to notify the user or the administrator. Furthermore, the alarming module 213 can send a notice message to the remote service platform through the peripheral interface device 113, which facilitates the remote service platform to handle further actions.

The download module 211 and the upload module 215 are stored in the memory and executed by the microprocessor. The download module 211 downloads information to the event signature database 207 or to the event regulation module 209 through the peripheral interlace device 113. The upload module 215 uploads the passed sense signal or other information to be shared to the remote service platform through the peripheral interface device 113.

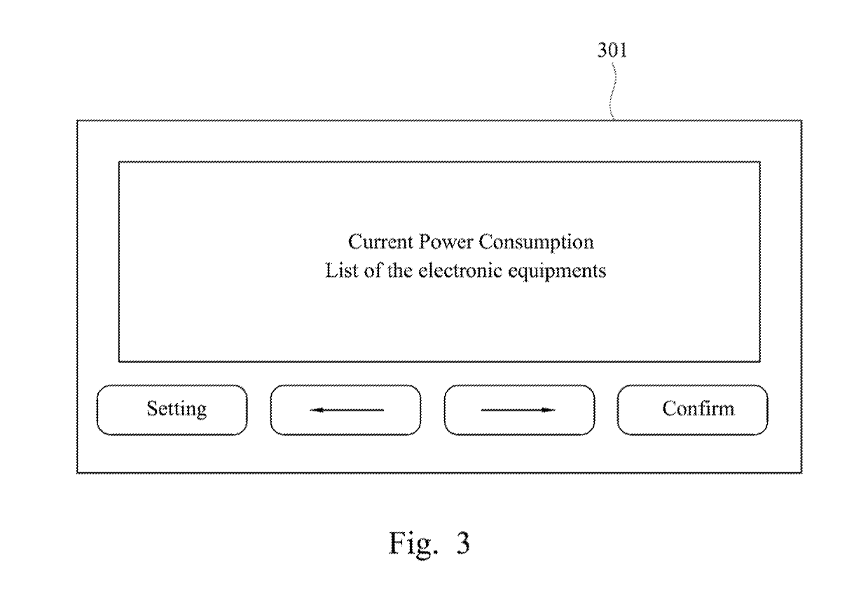

FIG. 3 is a diagram of a display device according to a second embodiment of the present invention. The display device displays information associated with the power socket and receives settings from inputs of a user. For example, the display device 301 displays the power consumption of the electronic equipment being used in watts. The display device 301 can also displays a list of the electronic equipments which are being used, such as a water heater, an air conditioner, a dehumidifier, an immersion heater, and an oven. The display device 301 can also be a touch panel for receiving settings inputted from the user or the administrator.

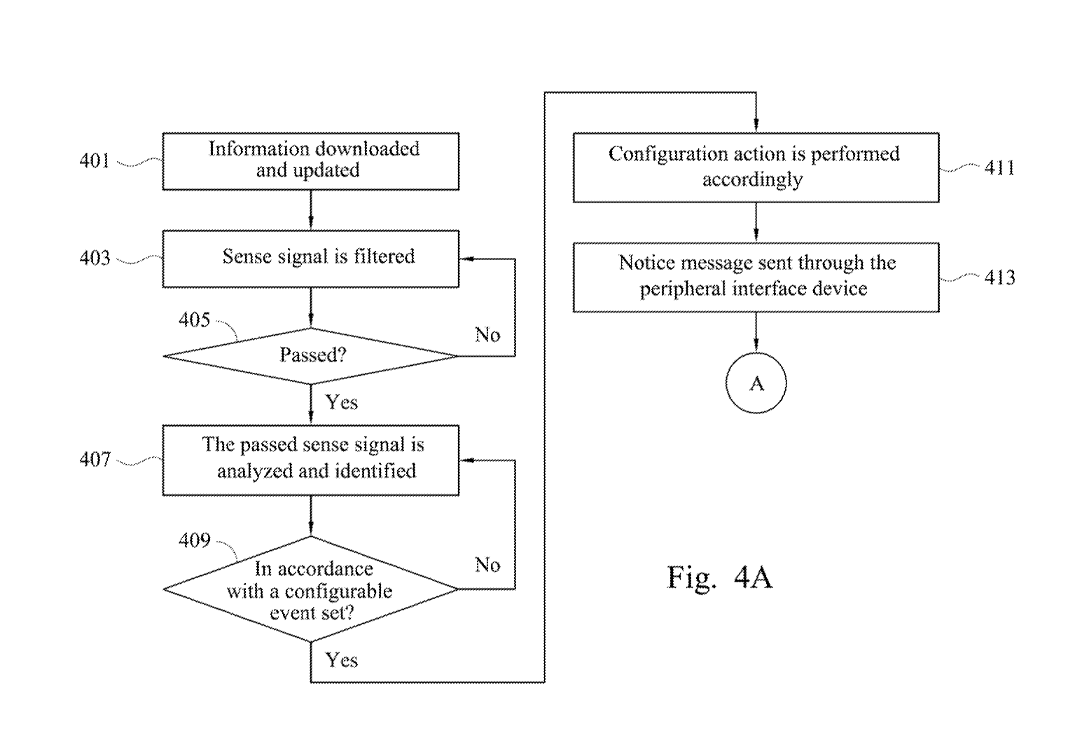

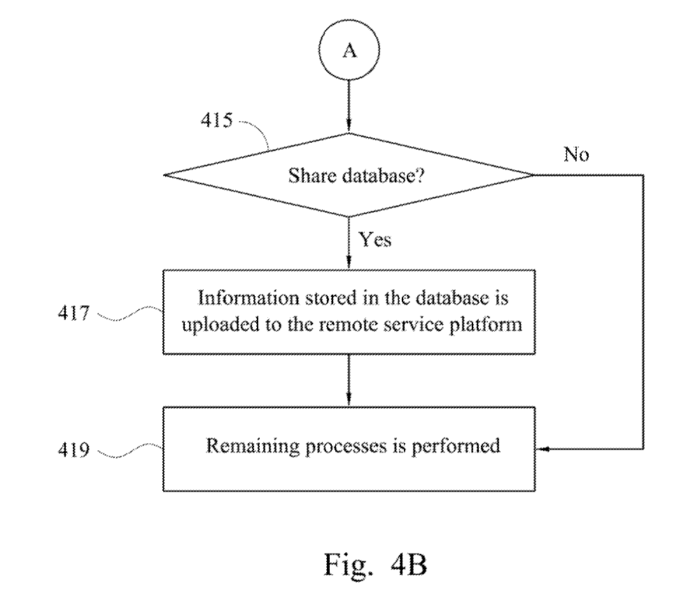

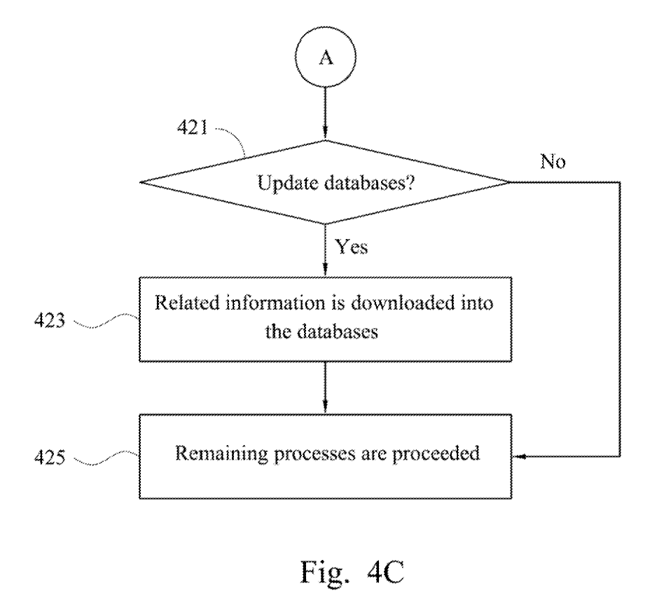

FIG. 4A is a part flowchart of a method for monitoring an appliance event according to a third embodiment of the present invention. In the method, corresponding information can be initially built-in or downloaded and updated in step 401. The sense signal which is corresponding to the power signal is filtered according to a filtering criterion step 403 by the front-end signal filter, and the sense signal is determined to be filtered out or passed in step 405. Next, the sense signal which is passed is analyzed and identified in step 407 to find out whether it is in accordance with a configurable event set in step 409. When the passed sense signal is in accordance with the configurable event set, at least one configuration action is performed according to the event handling regulations in step 411. A notice message can be further sent through the peripheral interface device in step 413.

FIG. 4B is another part flowchart of the method for monitoring the appliance event according to the third embodiment of the present invention, in which steps in FIG. 4B follow the steps in FIG. 4A. Whether the databases are shared is determined in step 415. If the databases are shared, the information stored in the database (such as the event storage database) is uploaded to the remote service platform in step 417. For example, settings of the front-end signal filter, the filtering criteria, the event handling regulations, the configurable event set information, the hardware settings, the software settings, the firmware settings (such as bit-streams of program record file), and a record file of the filtering criteria. The step 419 proceeds the remaining processes after step 417. The updated information stored in the remote service platform will be referenced and based by the administrator for future adjusting and updating, and the applicability as well as the analyzing identifying precision of the power socket can be further improved.

FIG. 4C is a remaining part flowchart of the method for monitoring the appliance event according to the third embodiment of the present invention, in which the steps in FIG. 4C follow the step 413 in FIG. 4A. In step 421, the databases are determined to be updated or not. When the databases are updated, related information is downloaded into the databases in step 423. After that, step 425 proceeds the remaining processes.

The power socket and the method for monitoring an appliance event of the above embodiments can block some appliance events according to the filtering criteria by the front-end signal filter, these blocked appliance events require no further process of the microprocessor, which reduces the burden of the microprocessor and improves the identifying efficiency. In addition, users or administrators can specify the configurable event set that the power socket can detect by themselves, and more electronic equipments can be identified. As a result, the electronic equipments can be managed more completed, and the environmental security can be further improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A power socket for monitoring an appliance event of a load, the power socket comprising:
a power sensor for sensing at least one power signal induced by the appliance event of the load and generating at least one sense signal accordingly;
a front-end signal filter for filtering the sense signal, wherein the sense signal is filtered out or passed by the front-end signal filter according to a filtering criterion;
a microprocessor for analyzing the sense signal which is passed to identify whether the passed sense signal is in accordance with a configurable event set, wherein a configuration action is performed by the power socket through an instruction of the microprocessor when the passed sense signal is analyzed and identified in accordance with the configurable event set; and
a memory electrically connected to the microprocessor.

2. The power socket of claim 1, further comprising:
an analog-digital converter electrically connected to the power sensor, wherein the analog-digital converter converts the sense signal from an analog type into a digital type.

3. The power socket of claim 1, further comprising:
an event storage database for storing the passed sense signal.

4. The power socket of claim 1, wherein the front-end signal filter is performed through a hardware circuit.

5. The power socket of claim 4, wherein the front-end signal filter is performed through a digital signal processor (DSP), a field-programmable gate array (FPGA), or an application specific Integrated circuit (ASIC).

6. The power socket of claim 1, further comprising:
a front-end filter database for storing the filtering criterion which is referenced by the front-end signal filter during the filtering to filter out or pass the sense signal.

7. The power socket of claim 1, further comprising:
a signature extraction module stored in the memory and executed by the microprocessor for extracting at least one under test signature from the passed sense signal;
an event signature database for storing signature information that is corresponding to the configurable event set; and
an event matching module stored in the memory and executed by the microprocessor for checking whether the under test signature is in accordance with signature information corresponding to the configurable event set.

8. The power socket of claim 7, wherein the configurable event set comprises a plurality of configurable appliance events.

9. The power socket of claim 7, wherein the under test signature is at least one of a real power, a reactive power, a root-mean-square, a harmonica, a voltage characteristic, and a current characteristic in the appliance event of the load.

10. The power socket of claim 7, further comprising:
an event regulation module stored in the memory, wherein a plurality of event handling regulations are recorded through the event regulation module; and
an event execution module stored in the memory and executed by the microprocessor, wherein the configuration action is performed according to the event handling regulations through an instruction of the event execution module when the under test signature is in accordance with the configurable event set.

11. The power socket of claim 10, further comprising:
a peripheral interface device for connecting to a remote service platform to perform a data transmission.

12. The power socket of claim 11, further comprising:
a download module stored in the memory and executed by the microprocessor, wherein the download module downloads information to the event signature database or to the event regulation module through the peripheral interface device.

13. The power socket of claim 11, further comprising:
an upload module stored in the memory and executed by the microprocessor, wherein the upload module uploads the passed sense signal to the remote service platform through the peripheral interface device.

14. The power socket of claim 11, further comprising:
an alarming module stored in the memory and executed by the microprocessor, wherein the alarming module is controlled by the event execution module to perform at least one alarming action, and the alarming module sends an notice message to the remote service platform through the peripheral interface device.

15. The power socket of claim 1, further comprising:
a display device for displaying information associated with the power socket and for receiving settings from inputs of an user.

16. A method for monitoring an appliance event of a load, the method comprising:
sensing at least one power signal induced by the appliance event of the load;
filtering a sense signal which is corresponding to the power signal according to a filtering criterion to filter out or to pass the sense signal;
analyzing the sense signal which is passed to identify whether the passed sense signal is in accordance with a configurable event set; and
instructing a power socket to perform a configuration action when the passed sense signal is analyzed and identified in accordance with the configurable event set,
wherein no configuration action is performed when the passed sense signal is not in accordance with the configurable event set.

17. The method of claim 16, further comprising:
instructing the power socket to perform the configuration action according to at least one of a plurality of event handling regulations when the passed sense signal is in accordance with the configurable event set.

18. The method of claim 17, wherein the analyzing is performed through extracting at least one under test signature from the passed sense signal and through checking whether the under test signature is in accordance with the configurable event set.

19. The method of claim 18, wherein the configurable event set and the event handling regulations are configured by a user.

20. The method of claim 17, wherein the configurable event set comprises:
at least a turning on action or a charging action of a general fan, a specific fan, a light, an electronic consumer device, a dehumidifier, an electronic cooking device, an air condition, and a heater.

21. The method of claim 17, further comprising:
downloading the filtering criterion, the event handling regulations, information associated with the configurable event set, hardware settings, software settings, firmware settings, and the bit streams.

22. The method of claim 17, further comprising:
uploading at least one of the filtering criteria, the event handling regulations, information associated with the configurable event set, hardware settings, software settings, firmware settings, and the bit streams to a remote service platform.
